(19) United States
(12) Patent Application Publication
(10) Pub. No.: US 2026/0159745 A1
(43) Pub. Date: Jun. 11, 2026

(54) POROUS MATERIAL FOR WELLBORE THERMAL INSULATION IN DRILLING AND ITS PREPARATION METHOD AND APPLICATION

(71) Applicant: CHINA UNIVESITY OF PETROLEUM (EAST CHINA) having, Qingdao (CN)

(72) Inventors: Mei-Chun Li, Qingdao (CN); Yang Ding, Qingdao (CN); Jinsheng Sun, Qingdao (CN); Kaihe Lv, Qingdao (CN); Jingping Liu, Qingdao (CN); Yingrui Bai, Qingdao (CN); Xianbin Huang, Qingdao (CN); Jintang Wang, Qingdao (CN); Jiafeng Jin, Qingdao (CN); Jian Li, Qingdao (CN)

(73) Assignee: CHINA UNIVESITY OF PETROLEUM (EAST CHINA), Qingdao (CN)

(21) Appl. No.: 19/316,077

(22) Filed: Sep. 2, 2025

(30) Foreign Application Priority Data
Dec. 6, 2024 (CN) 202411791450.7

(51) Int. Cl. C09K 8/24; C04B 33/132; C04B 33/135; C04B 33/32; C04B 35/626; C04B 38/00; C04B 38/06; C04B 41/45; C04B 41/48; C09K 8/16; E21B 36/00

(52) U.S. Cl. CPC C09K 8/24; C04B 33/1328; C04B 33/1352; C04B 33/32; C04B 35/62695; C04B 38/0054; C04B 38/067; C04B 41/4539; C04B 41/4849; C09K 8/16; E21B 36/003; C04B 2235/3463; C04B 2235/6567; C04B 2235/9607

(57) ABSTRACT

This invention provides a porous material for wellbore thermal insulation in drilling, its preparation method, and application, belong to the field of oilfield chemical technology. The preparation method of the porous material comprises the steps of: thoroughly mixing ceramic powder and a pore-forming agent; prilling using a colloidal solution as a binder; then subjecting to heat treatment to obtain porous ceramsite; dispersing porous ceramsite, an anionic monomer, and a cationic monomer in deionized water; adding an initiator for reaction; then washing and drying to obtain the final product. The porous material utilizes natural minerals and industrial waste as raw materials, which are low-cost, readily available, and environmentally friendly. When applied for wellbore thermal insulation, the porous material prevents screening removal by solid-liquid separation equipment, enabling multiple reuse cycles. The porous material exhibits abundant micron/nano-scale pores internally, delivering low thermal conductivity and superior insulation performance.

### CROSS-REFERENCE TO RELATED APPLICATIONS

This application claims priority to Chinese Patent Application Ser. No. CN202411791450.7 filed on 6 Dec. 2024.

### FIELD OF THE INVENTION

The invention belongs to the technical field of oilfield chemistry, and specifically relates to a porous material for wellbore thermal insulation in drilling and its preparation method and application.

### BACKGROUND OF THE INVENTION

As the demand for oil and gas resources continuously increases and the reserves of shallow and medium-depth oil and gas are gradually depleting, the development of deep oil and gas has become imperative. China has abundant deep oil and gas resources, but their development poses extreme challenges, particularly the high-temperature difficulties encountered during drilling. When drilling depths exceed 8000 μm, the wellbore temperature can reach over 200° C. The resulting drilling fluid failure, drill string damage, and logging-while-drilling equipment failure make drilling extremely difficult. More severely, this may even trigger major accidents such as lost circulation, borehole collapse, and blowouts, leading to incalculable economic losses. Therefore, reducing wellbore temperature is crucial for deep oil and gas development.

The wellbore temperature primarily originates from heat transfer from the high-temperature formation. The heat from the deep formation transfers to the wellbore wall and subsequently to the drilling fluid and drill pipe. Establishing an insulation layer on the wellbore wall holds promise for reducing heat transfer from the formation into the wellbore, thereby lowering the wellbore temperature. Porous ceramsite is a lightweight porous material made from clay, shale, or industrial waste. It boasts advantages like ease of processing, low cost, high strength, and low thermal conductivity, leading to its widespread application in fields such as construction and horticulture. However, existing porous ceramsites have excessively large particle sizes, making them prone to sieving out by solid-liquid separation devices and hindering multiple reuse cycles. Their thermal conductivity is still too high, leaving room for improvement in insulation performance. Furthermore, their surface characteristics prevent adsorption onto the wellbore wall rock for insulation, and modification proves difficult. For example, the invention patent CN118495983A discloses a composite porous ceramsite based on Yunnan red soil and its preparation method. It produces a ceramsite with high specific surface area, high porosity, and high strength, along with nanopores, using a simple process. However, the particle size of this ceramsite is very large (4.5-7 mm), and without surface modification, it cannot be used for wellbore insulation. Invention patent CN114276084A discloses an insulating ceramsite wall panel, which describes the preparation of modified ceramsite. The ceramsite surface is first activated with cetyltrimethylammonium bromide (CTAB), allowing adsorption of periclase powder, and finally, tetraethyl orthosilicate (TEOS) is used to form a silica layer on the outer surface. Nevertheless, constrained by its particle size and high thermal conductivity, this modified ceramsite cannot be applied in the field of wellbore insulation.

Consequently, the problem of drilling difficulties caused by wellbore ultra-high temperatures remains unresolved. There is an urgent need to develop new technologies to lowering wellbore temperature.

### SUMMARY OF THE INVENTION

In view of the shortcomings of the existing technology, this invention provides a porous material for wellbore thermal insulation in drilling and its preparation method and application. The porous material of this invention uses natural minerals and industrial waste as raw materials, which are low-cost, readily available, and environmentally friendly. The particle size of the porous material can be reduced to below 100 μm. When applied for wellbore thermal insulation, this prevents the ceramsite from being sieved out by solid-liquid separation equipment, facilitating multiple reuse cycles. The interior of the porous material contains numerous of micron-scale and nano-scale pores, resulting in low thermal conductivity and excellent thermal insulation performance. The surface of the porous material contains abundant anionic and cationic functional groups, enabling it to adsorb onto the wellbore wall to provide effective and stable thermal insulation.

### DETAILED DESCRIPTION OF THE INVENTION

A porous material for wellbore thermal insulation in drilling, wherein the porous material has a spherical structure, a thermal conductivity of 0.03-0.07 W/m·K, a porosity of 80%-95%, and a compressive strength of 1-3 MPa. This porous material possesses a multilevel cellular structure with pore sizes ranging from 0.01-20 μm. The surface of this porous material bears both anionic and cationic functional groups.

According to a preferred embodiment of the present invention, the porous material has a spherical structure with a thermal conductivity of 0.038-0.048 W/m·K, a porosity of 82%-88%, and a compressive strength of 1.2-2.3 MPa. This porous material possesses a hierarchically cellular microstructure with a pore size distribution of 0.01-13 μm. The surface of this porous material is functionalized with both anionic and cationic groups.

The preparation method of the wellbore thermal insulation porous material, comprising the following steps:
(1) thoroughly mixing ceramic powder and a pore-forming agent to uniformity to obtain mixed powder; using a colloidal solution as a binder to form ceramsite microspheres via prilling; then subjecting to heat treatment to obtain porous ceramsite;
the ceramic powder is one or a combination of two or more selected from clay, shale powder, fly ash, coal gangue, or iron tailings; the pore-forming agent is a combination of micron-scale particles and nano-scale particles, wherein the micron-scale particles are polypropylene, polyethylene, or polystyrene micron-scale particles, and the nano-scale particles are polypropylene, polyethylene, or polystyrene nano-scale particles; the colloidal solution is one or a combination of two or more selected from polyvinyl alcohol aqueous solution, polyacrylamide aqueous solution, or polyethylene glycol aqueous solution;
(2) uniformly dispersing porous ceramsite, an anionic monomer, and a cationic monomer in deionized water; adding an initiator and conduct a reaction, then washing and drying to obtain the porous material for wellbore thermal insulation in drilling;
the anionic monomer is one or a combination of two or more selected from 2-acrylamido-2-methylpropanesulfonic acid, sodium styrenesulfonate, sodium vinylsulfonate, sodium acrylatesulfonate, acrylic acid, methacrylic acid, or 2-hydroxyethyl acrylic acid; the cationic monomer is one or a combination of two or more selected from diallyldimethylammonium chloride, poly(acrylamide ammonium salt), or polyquaternary ammonium salt; the initiator is one or a combination of two or more selected from ammonium persulfate, sodium bisulfite, or 2,2′-azobis[2-(2-imidazolin-2-yl)propane]dihydrochloride.

According to the preferred embodiment of the invention, in step (1), the ceramic powder is a combination of fly ash and coal gangue, wherein, the mass ratio of fly ash to coal gangue is 1:0.5-1.

According to the preferred embodiment of the invention, in step (1), the particle size of the ceramic powder is 0.5-20 μm, preferably 5-12 μm.

According to the preferred embodiment of the invention, in step (1), in the pore-forming agent, the particle size of micron-scale particles is 6-13 μm, the particle size of nano-scale particles is 100-500 nm; the mass ratio of micron-scale particles to nano-scale particles is 2-4:1, preferably 3:1.

According to the preferred embodiment of the invention, in step (1), the mass ratio of the ceramic powder to the pore-forming agent is 3.75-5:1.

According to the preferred embodiment of the invention, in step (1), mixing of the ceramic powder and the pore-forming agent is performed in a round pot granulator.

According to a preferred embodiment of the present invention, in step (1), the concentration of the colloidal solution is 0.1-0.8 wt %, preferably 0.5 wt %.

According to the preferred embodiment of the invention, in step (1), the mass ratio of the mixed powder to the colloidal solution is 1:0.001-0.1.

According to the preferred embodiment of the invention, in step (1), prilling is performed in a round pot granulator; the mixed powder is rotated in the round pot granulator during rotation, the colloidal solution is sprayed onto the surface of the mixed powder using a nano-atomizer; under the action of gravity and rotation, the mixed powder forms agglomerated micron-scale spheres; after drying, ceramsite microspheres are obtained; wherein, the rotation speed is 10-200 r/min, the rotation time is 2-10 min, and the spraying speed of the nano-atomizer is 30-1000 mL/min.

According to the preferred embodiment of the invention, in step (1), the heat treatment temperature is 1000-1500° C., the heat treatment time is 2-10 h, and the heat treatment atmosphere is air.

According to a preferred embodiment of the invention, in step (2), the mass ratio of porous ceramsite:anionic monomer:cationic monomer:initiator:deionized water is 1:(0.01-0.1):(0.005-0.1):(0.005-0.01):(0.5-3), preferably 1:0.05:0.05:0.005:1.

According to a preferred embodiment of the invention, in step (2), the initiator is used in the form of an initiator aqueous solution, and the concentration of the initiator aqueous solution is 0.5-5 wt %.

According to a preferred embodiment of the invention, in step (2), the reaction temperature is 20-80° C., preferably 60-80° C., the reaction time is 6-12 h, and the reaction is conducted under oxygen-free conditions, with protective gas shielding, and stirring; preferably, the protective gas is nitrogen or argon.

According to a preferred embodiment of the invention, in step (2), washing is performed using deionized water.

Application of the aforementioned porous material for wellbore thermal insulation in drilling, used as a thermal insulation material for thermal insulation in ultra-deep drilling boreholes.

According to a preferred embodiment of the invention, the ultra-deep formation has a depth ≥8000m.

The technical features and beneficial effects of the invention are as follows:
(1) This invention utilizes natural minerals and industrial waste as raw materials, which are low-cost and readily available, significantly reducing production costs. This approach is environmentally friendly and achieves resource utilization of waste materials. The preparation method of this invention is simple, easily implementable, and suitable for industrial-scale production.
(2) This invention employs ultrafine ceramic powder as raw material, micron-scale and nano-scale hierarchical polymer particles as pore-forming agents, and a colloidal solution as a binder. Through rotary granulation with nano-spray assistance combined with heat treatment, porous ceramsite with a hierarchical cellular structure is prepared. This enables ultra-fine particle sizes (<100 μm) and abundant micron- and nano-scale pores. The method ensures that: Particle size ≤100 μm prevents removal by solid-liquid separation devices during drilling fluid circulation, enabling multiple reuse cycles; Internally structured with dense micron/nano dual-scale pores, delivering high porosity (82-88%), ultra-low thermal conductivity (0.038-0.048 W/(m·K)), and superior insulation performance; High mechanical strength (1.2-2.3 MPa) for field durability.
(3) This invention modifies porous ceramsite with both anionic and cationic functional groups, enabling adsorption onto wellbore walls regardless of surface charge polarity, thereby achieving stable and effective thermal insulation.

### EXAMPLES

The invention will be further described with the follow examples, but not limited to that.

In the following Embodiments, the experimental methods described are all conventional methods unless otherwise specified; the reagents and materials referred to are all commercially available unless otherwise specified.

### Example 1

A preparation method for a porous material for wellbore thermal insulation in drilling, comprising the following steps:
(1) Thoroughly mix fly ash, coal gangue, polypropylene micron-scale particles, and polystyrene nano-scale particles in a round pot granulator to form a homogeneous mixed powder, wherein, the mass ratio of fly ash:coal gangue:polypropylene micron-scale particles:polystyrene nano-scale particles=1:1:0.3:0.1; the particle size of fly ash is 6-12 μm; the particle size of coal gangue is 5-12 μm; the particle size of polypropylene micron-scale particles is 6-13 μm; and the particle size of polystyrene nano-scale particles is 100-500 nm.
(2) Rotate the mixed powder from step (1) in the round pot granulator; during rotation, spray a 0.5 wt % polyvinyl alcohol aqueous solution (Mw=9000-10000) onto the surface of the mixed powder using a nano-atomizer; under gravity and rotation, the powder forms agglomerated micron-scale spheres; dry to obtain ceramsite microspheres; herein, the rotation speed is 50 r/min; the rotation time is 3 min; the spraying speed of the nano-atomizer is 80 mL/min; and the mass ratio of mixed powder to PVA aqueous solution=1:0.05.
(3) Heat-treat the ceramsite microspheres from step (2) in a muffle furnace to obtain porous ceramsite; wherein, the heat treatment temperature is 1300° C.; the heat treatment time is 3 h; and the heat treatment atmosphere is air.
(4) Place porous ceramsite from step (3), 2-acrylamido-2-methylpropanesulfonic acid, diallyldimethylammonium chloride, and deionized water in a three-neck flask; remove oxygen under a N₂ atmosphere; then add a 3 wt % ammonium persulfate aqueous solution and react with continuous stirring at 70° C. for 8 h; after reaction completion, wash the product with deionized water and dry to obtain the porous material for wellbore thermal insulation; wherein, the mass ratio of porous ceramsite:2-acrylamido-2-methylpropanesulfonic acid:diallyldimethylammonium chloride:deionized water:ammonium persulfate=1:0.05:0.05:1:0.005.

In the EXAMPLE 1, the porous ceramsite has a particle size of 60-80 μm; the thermal conductivity is 0.045 W/(m·K), porosity is 85%, compressive strength is 2.2 MPa, and it possesses a hierarchical cellular structure with pore sizes of 0.01-13 μm, while bearing both anionic and cationic functional groups on its surface.

### Example 2

A preparation method for a porous material for wellbore thermal insulation in drilling, as described in EXAMPLE 1, with the difference that: in step (1), the mass ratio of fly ash:coal gangue:polypropylene micron-scale particles:polystyrene nano-scale particles=1:0.8:0.3:0.1. Other steps and conditions are identical to EXAMPLE 1.

In the EXAMPLE 2, the porous ceramsite has a particle size of 60-80 μm; the thermal conductivity of the porous material is 0.041 W/(m·K), porosity is 86%, compressive strength is 1.6 MPa, and it possesses a hierarchical cellular structure with pore sizes of 0.01-13 μm, while bearing both anionic and cationic functional groups on its surface.

### Example 3

A preparation method for a porous material for wellbore thermal insulation in drilling, as described in EXAMPLE 1, with the difference that: in step (1), the mass ratio of fly ash:coal gangue:polypropylene micron-scale particles:polystyrene nano-scale particles=1:0.5:0.3:0.1. Other steps and conditions are identical to EXAMPLE 1.

In the EXAMPLE 3, the porous ceramsite has a particle size of 60-80 μm; the thermal conductivity of the porous material is 0.038 W/(m·K), porosity is 88%, compressive strength is 1.3 MPa, and it possesses a hierarchical cellular structure with pore sizes of 0.01-13 μm, while bearing both anionic and cationic functional groups on its surface.

### Example 4

A preparation method for a porous material for wellbore thermal insulation in drilling, as described in EXAMPLE 1, with the difference that: in step (2), the rotation time for prilling is 5 min. Other steps and conditions are identical to EXAMPLE 1.

In the EXAMPLE 4, the porous ceramsite has a particle size of 70-90 μm; the thermal conductivity of the porous material is 0.040 W/(m·K), porosity is 87%, compressive strength is 1.2 MPa, and it possesses a hierarchical cellular structure with pore sizes of 0.01-13 μm, while bearing both anionic and cationic functional groups on its surface.

### Example 5

A preparation method for a porous material for wellbore thermal insulation in drilling, as described in EXAMPLE 1, with the difference that: in step (4), the mass ratio of porous ceramsite:2-acrylamido-2-methylpropanesulfonic acid:diallyldimethylammonium chloride:deionized water:ammonium persulfate=1:0.01:0.005:1:0.005. Other steps and conditions are identical to EXAMPLE 1.

In the EXAMPLE 5, the porous ceramsite has a particle size of 60-80 μm; the thermal conductivity of the porous material is 0.044 W/(m·K), porosity is 86%, compressive strength is 2.0 MPa, and it possesses a hierarchical cellular structure with pore sizes of 0.01-13 μm, while bearing both anionic and cationic functional groups on its surface.

### Example 6

A preparation method for a porous material for wellbore thermal insulation in drilling, as described in EXAMPLE 1, with the difference that: in step (4), the mass ratio of porous ceramsite:2-acrylamido-2-methylpropanesulfonic acid:diallyldimethylammonium chloride:deionized water:ammonium persulfate=1:0.1:0.1:1:0.005. Other steps and conditions are identical to EXAMPLE 1.

In the EXAMPLE 6, the porous ceramsite has a particle size of 60-80 μm; the thermal conductivity of the porous material is 0.048 W/(m·K), porosity is 82%, compressive strength is 2.3 MPa, and it possesses a hierarchical cellular structure with pore sizes of 0.01-13 μm, while bearing both anionic and cationic functional groups on its surface.

### Comparative Example 1

A preparation method for a porous material for wellbore thermal insulation in drilling, as described in EXAMPLE 1, with the difference that: in step (1), the mass ratio of fly ash:coal gangue:polypropylene micron-scale particles:polystyrene nano-scale particles=1:0.1:0.3:0.1. Other steps and conditions are identical to EXAMPLE 1.

In the COMPARATIVE EXAMPLE 1, the porous ceramsite has a particle size of 60-80 m; the thermal conductivity of the porous material is 0.027 W/(m K), porosity is 94%, and it possesses a hierarchical cellular structure with pore sizes of 0.01-13 μm, while bearing both anionic and cationic functional groups on its surface; however, due to the insufficient addition of coal gangue, the reinforcement phase fails to uniformly infiltrate the skeletal structure of the porous ceramsite, resulting in a drastic reduction of compressive strength to merely 0.5 MPa.

### Comparative Example 2

A preparation method for a porous material for wellbore thermal insulation in drilling, as described in EXAMPLE 1, with the difference that: in step (1), the mass ratio of fly ash:coal gangue:polypropylene micron-scale particles:polystyrene nano-scale particles=1:2:0.3:0.1. Other steps and conditions are identical to EXAMPLE 1.

In the COMPARATIVE EXAMPLE 2, the porous ceramsite has a particle size of 60-80 m; the thermal conductivity of the porous material is 0.087 W/(m K), porosity is 64%, and it possesses a hierarchical cellular structure with pore sizes of 0.5-10 μm, while bearing both anionic and cationic functional groups on its surface; however, due to the excessive addition of coal gangue, substantial reinforcement phase infiltrates the skeletal structure of the porous ceramsite, resulting in reduced porosity and pore size, while compressive strength increases to 5 MPa.

### Comparative Example 3

A preparation method for a porous material for wellbore thermal insulation in drilling, as described in EXAMPLE 1, with the difference that: in step (2), the mass fraction of the polyvinyl alcohol aqueous solution sprayed is 1 wt %. Other steps and conditions are identical to EXAMPLE 1.

In the COMPARATIVE EXAMPLE 3, the porous ceramsite has a particle size of 200-1000 μm; the thermal conductivity of the porous material is 0.065 W/(m K), porosity is 73%, compressive strength is 3 MPa, and it possesses a hierarchical cellular structure with pore sizes of 0.1-50 μm, while bearing both anionic and cationic functional groups on its surface; however, due to the increased mass fraction of the polyvinyl alcohol colloidal solution, the viscosity of nucleated particles during rotary prilling increases, adsorbing substantial free material and resulting in enlarged particle size and pore dimensions of the porous ceramsite, thereby elevating thermal conductivity.

### Comparative Example 4

A preparation method for a porous material for wellbore thermal insulation in drilling, as described in EXAMPLE 1, with the difference that: step (4) is omitted, and no modification is performed on the porous ceramsite. Other steps and conditions are identical to EXAMPLE 1.

In the COMPARATIVE EXAMPLE 4, the porous ceramsite has a particle size of 60-80 m; the thermal conductivity of the porous material is 0.043 W/(m K), porosity is 87%, compressive strength is 2.1 MPa, and it possesses a hierarchical cellular structure with pore sizes of 0.01-13 am; but its surface bears no anionic or cationic functional groups.

The particle size, thermal conductivity, porosity, compressive strength, and pore size of porous ceramsite for EXAMPLE 1-6 and COMPARATIVE EXAMPLE 1-4 are summarized in Table 1

TABLE 1
The particle size, thermal conductivity, porosity, compressive
strength, and pore size of porous ceramsite

| | | Thermal | | Compressive | |
|---|---|---|---|---|---|
| Testing Object | Particle Size | Conductivity | Porosity | Strength | Pore Size |
| EXAMPLE 1 | 60~80 μm | 0.045 W/(m · k) | 85% | 2.2 MPa | 0.01~13 μm |
| EXAMPLE 2 | 60~80 μm | 0.041 W/(m · k) | 86% | 1.6 MPa | 0.01~13 μm |
| EXAMPLE 3 | 60~80 μm | 0.038 W/(m · k) | 88% | 1.3 MPa | 0.01~13 μm |
| EXAMPLE 4 | 70~90 μm | 0.040 W/(m · k) | 87% | 1.2 MPa | 0.01~13 μm |
| EXAMPLE 5 | 60~80 μm | 0.044 W/(m · k) | 86% | 2.0 MPa | 0.01~13 μm |
| EXAMPLE 6 | 60~80 μm | 0.048 W/(m · k) | 82% | 2.3 MPa | 0.01~13 μm |
| COMPARATIVE | 60~80 μm | 0.027 W/(m · k) | 94% | 0.5 MPa | 0.01~13 μm |
| EXAMPLE 1 | | | | | |
| COMPARATIVE | 60~80 μm | 0.087 W/(m · k) | 64% | 5 MPa | 0.5~10 μm |
| EXAMPLE 2 | | | | | |
| COMPARATIVE | 200~1000 μm | 0.065 W/(m · k) | 73% | 3 MPa | 0.1~50 μm |
| EXAMPLE 3 | | | | | |
| COMPARATIVE | 60~80 μm | 0.043 W/(m · k) | 87% | 2.1 MPa | 0.01~13 μm |
| EXAMPLE 4 | | | | | |

As shown in Table 1, in the EXAMPLE: With decreasing dosage of coal gangue, the total mass percentage of mixed powder decreases accordingly, while the mass percentage of pore-forming agent increases. This leads to increased porosity, reduced thermal conductivity, and decreased strength of the porous ceramsite. However, the particle size and pore dimensions of the porous ceramsite are almost unaffected. With increasing rotation time, the size of the ceramsite also enlarges. This is because additional powder continuously adheres to the ceramsite during rotation, causing growth, but with minimal impact on performance. In COMPARATIVE EXAMPLE 1, excessive reduction of coal gangue mass results in increased porosity and reduced thermal conductivity of the porous ceramsite, but causes severe strength degradation. In COMPARATIVE EXAMPLE 2, excessive addition of coal gangue mass leads to decreased porosity and increased thermal conductivity, but triggers a drastic strength increase. In COMPARATIVE EXAMPLE 3, increased concentration of colloidal solution elevates its viscosity. When sprayed onto mixed powder, it agglomerates large powder clusters into spheres, enlarging particle size while increasing compactness and strength. In COMPARATIVE EXAMPLE 4, without modification of porous ceramsite, porosity slightly increases while thermal conductivity rises (0.043 W/(m·K)).

### Test Example 1

### Study on Thermal Insulation Performance of Porous Material

(1) Prepare a base mud composed of water, bentonite, and anhydrous sodium carbonate at a mass ratio of 100:2:1.
(2) Disperse porous materials prepared in EXAMPLE 1-3 into the base mud from step (1), and filter to form mud cakes. The mass ratios of base mud to porous material are 1:0.005, 1:0.01, and 1:0.03, respectively.
(3) Place the mud cakes from step (2) on a heating stage, heat at a constant temperature of 200° C. for 30 min, and monitor surface temperature using an infrared camera.

Thermal insulation effects of pure mud cakes (without porous material) and mud cakes with different mass ratios of porous material are listed in Table 2.

TABLE 2
Thermal insulation effects of mud cakes

| | | Temperature |
|---|---|---|
| Composition of Mud Cake | Mass Ratio | Difference |
| Based mud | — | 5° C. |
| Based mud + EXAMPLE 1 | 1:0.005 | 10° C. |
| porous materials | | |
| Based mud + EXAMPLE 2 | 1:0.005 | 12° C. |
| porous materials | | |
| Based mud + EXAMPLE 3 | 1:0.005 | 13° C. |
| porous materials | | |
| Based mud + EXAMPLE 1 | 1:0.01 | 17° C. |
| porous materials | | |
| Based mud + EXAMPLE 2 | 1:0.01 | 19° C. |
| porous materials | | |
| Based mud + EXAMPLE 3 | 1:0.01 | 20° C. |
| porous materials | | |
| Based mud + EXAMPLE 1 | 1:0.03 | 22° C. |
| porous materials | | |
| Based mud + EXAMPLE 2 | 1:0.03 | 25° C. |
| porous materials | | |
| Based mud + EXAMPLE 3 | 1:0.03 | 26° C. |
| porous materials | | |

As shown in Table 2, the mud cakes incorporating the porous material exhibit superior thermal insulation performance. With increasing additive amount and decreasing thermal conductivity of the porous material, the temperature difference across the mud cake significantly increases. This is primarily attributed to the uniform dispersion of porous material within the mud cake, where its complex cellular microstructure (versus solid matrices) extends heat transfer pathways, thereby amplifying temperature difference.

### Protection Scope Declaration

The foregoing describes specific implementations of the present invention; however, the inventive concept is not limited thereto. Any non-essential variations exploiting this concept shall constitute infringement of the patent rights. Conversely, modifications retaining the core technical solution—including simple adaptations, equivalent alterations, or structural refinements based on the technical essence of the invention—shall remain within the protection scope of this patent.

What is claimed is:

1. A method for preparing a wellbore thermal insulation porous material, comprising the following steps:
(1) thoroughly mixing ceramic powder and a pore-forming agent to uniformity to obtain mixed powder; using a colloidal solution as a binder to form ceramsite microspheres via prilling; then subjecting to heat treatment to obtain porous ceramsite;
the ceramic powder is one or a combination of two or more selected from clay, shale powder, fly ash, coal gangue, or iron tailings; the pore-forming agent is a combination of micron-scale particles and nano-scale particles, wherein the micron-scale particles are polypropylene, polyethylene, or polystyrene micron-scale particles, and the nano-scale particles are polypropylene, polyethylene, or polystyrene nano-scale particles; the colloidal solution is one or a combination of two or more selected from polyvinyl alcohol aqueous solution, polyacrylamide aqueous solution, or polyethylene glycol aqueous solution;
the particle size of ceramic powder is 0.5-20 μm; in the pore-forming agent, the particle size of micron-scale particles is 6-13 μm, the particle size of nano-scale particles is 100-500 nm; the mass ratio of micron-scale particles to nano-scale particles is 2-4:1; the mass ratio of ceramic powder to pore-forming agent is 3.75-5:1; the concentration of the colloidal solution is 0.1-0.8 wt %; the mass ratio of mixed powder to colloidal solution is 1:0.001-0.1;
(2) uniformly dispersing porous ceramsite, an anionic monomer, and a cationic monomer in deionized water; adding an initiator and conduct a reaction, then washing and drying to obtain the porous material for wellbore thermal insulation in drilling;
the anionic monomer is one or a combination of two or more selected from 2-acrylamido-2-methylpropanesulfonic acid, sodium styrenesulfonate, sodium vinylsulfonate, sodium acrylatesulfonate, acrylic acid, methacrylic acid, or 2-hydroxyethyl acrylic acid; the cationic monomer is one or a combination of two or more selected from diallyldimethylammonium chloride, poly(acrylamide ammonium salt), or polyquaternary ammonium salt; the initiator is one or a combination of two or more selected from ammonium persulfate, sodium bisulfite, or 2,2′-azobis[2-(2-imidazolin-2-yl)propane]dihydrochloride;
the mass ratio of porous ceramsite:anionic monomer:cationic monomer:initiator:deionized water=1:(0.01-0.1):(0.005-0.1):(0.005-0.01):(0.5-3).

2. The method according to claim 1, wherein in the step (1), the ceramic powder is a combination of fly ash and coal gangue, wherein, the mass ratio of fly ash to coal gangue is 1:0.5-1.

3. The method according to claim 1, wherein in the step (1), prilling is performed in a round pot granulator.

4. The method according to claim 1, wherein in the step (1), one or more of the following conditions are included:
(1) prilling is performed in a round pot granulator; the mixed powder is rotated in the round pot granulator; during rotation, a colloidal solution is sprayed onto the surface of the mixed powder using a nano-atomizer; under gravity and rotation, the mixed powder forms agglomerated micron-scale spheres, which are dried to obtain green ceramsite microspheres, wherein, the rotation speed of the rotary pot granulator is 10-200 rpm, the rotation time is 2-10 min, and the spraying speed of the nano-atomizer is 30-1000 mL/min;
(2) the heat treatment temperature is 1000-1500° C., the heat treatment time is 2-10 h, and the heat treatment atmosphere is air.

5. The method according to claim 1, wherein in the step (2), one or more of the following conditions are included:
(1) the initiator is used in the form of an initiator aqueous solution, and the concentration of the initiator aqueous solution is 0.5-5 wt %;
(2) the reaction temperature is 20-80° C., the reaction time is 6-12 h, and the reaction is conducted under oxygen-free conditions, protective gas atmosphere, and with stirring.

6. The method according to claim 1, wherein the porous material has a spherical structure, a thermal conductivity of 0.03-0.07 W/(m·K), a porosity of 80-95%, and a compressive strength of 1-3 MPa; the porous material possesses a multilevel cellular structure with pore sizes of 0.01-20 m; and the surface of the porous material bears both anionic and cationic functional groups.

7. The method according to claim 1, wherein the porous material has a spherical structure, a thermal conductivity of 0.038-0.048 W/(m·K), a porosity of 82-88%, and a compressive strength of 1.2-2.3 MPa; the porous material possesses a multilevel cellular structure with pore sizes of 0.01-13 μm; and the surface of the porous material bears both anionic and cationic functional groups.

8. A process for utilizing the porous material of claim 1 for wellbore thermal insulation in drilling, comprising the porous material is used as a thermal insulation material for thermal insulation in ultra-deep drilling wellbore.

9. The process according to claim 8, wherein the ultra-deep formation has a depth ≥8000 μm.
